(19) United States
(12) Patent Application Publication
(10) Pub. No.: US 2009/0220790 A1
(43) Pub. Date: Sep. 3, 2009

(54) Spinel Nanopowders

(75) Inventors: Woohong Kim, Lorton, VA (US); Jasbinder S. Sanghera, Ashburn, VA (US); Guillermo R. Villalobos, Springfield, VA (US); Shyam S. Bayya, Ashburn, VA (US); Ishwar D. Aggarwal, Fairfax Station, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The government of the Us as represented by the Secretary of the Navy, Washington, DC (US)

(21) Appl. No.: 12/362,430

(22) Filed: Jan. 29, 2009

Related U.S. Application Data
(60) Provisional application No. 61/024,358, filed on Jan. 29, 2008.

(51) Int. Cl. B32B 1/00; C01F 7/02; C01F 5/00

(52) U.S. Cl. 428/402; 423/600; 977/811

(57) ABSTRACT

Disclosed is a method of producing a spinel powder comprising preparing a double-hydroxide precursor precipitate then treating the precipitate with a washing agent, wherein said washing agent replaces water in said precipitate, then drying the precipitate to produce a hydroxide powder. The hydroxide powder is calcinated to produce an spinel powder that is essentially free of agglomeration.

### CROSS-REFERENCE TO RELATED APPLICATIONS

This application is a Non-Prov of Prov (35 USC 119(e)) application 61/024358 filed on Jan. 29, 2008, the entirety of which is incorporated herein by reference. This application is related to U.S. patent application Ser. No. 11/094,545, U.S. patent application Ser. No. 11,094,544, now issued as U.S. Pat. No. 7,211,325, and U.S. patent application Ser. No. 11/094,544, which is a divisional of U.S. patent application Ser. No. 10/601,884, each of which is incorporated herein in their entirety by reference.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

Sintering is defined as the act of consolidating powder into a dense shape. The powder being sintered must additionally not melt to a great extent, some melting of secondary phases in the powder, or surface melting is allowed under this definition. If the material completely melts, the process is referred to as fusion casting. Sintering, both pressureless and with pressure, or hot pressing, requires solid, liquid or gas material transport to consolidate an aggregate of loose powder particles into a dense shape. In the case of porcelains and clay products, secondary phases do melt and “glue” the primary solid particles together with a glassy phase. These types of systems were the first to be used due to their ease of sintering. However, advanced ceramics do not have these intrinsic sintering aids and they must therefore, be added. For small samples, the powdered sintering aids are mixed with the powder to be sintered with a mortar and pestle. In larger samples, mixing is accomplished by ball milling, attritor milling, high shear wet milling, and variations or combinations of these methods.

Spinel is defined as a crystalline structure of the type AB₂O₄ where A is a 2+ cation occupying tetrahedral lattice site in an oxygen cubic close packed structure and B is a 3+ cation occupying octahedral lattice site. In a preferred embodiment, spinel is MgAl.₂O₄ consisting of an oxide of magnesium and aluminum. Spinel powder can be prepared by wet chemistry, solid state diffusion of oxides or calcination. Spinel powder particles consist of crystallites which are less than 500 nm in size that can also be agglomerated into larger sizes varying from 500 nm to 100 μm, more typically 1-50 μm.

Spinel is important because it is strong and transparent from visible to 5.5 μm wavelength. Its mechanical properties are several times greater than that of glass and make it a leading candidate for use as a transparent armor and window material. Commercially, it can be used as a stronger and thinner window for many applications including lap top computers, cell phones, automotive glassing and headlamps, aerospace windshields, and industrial blast shields.

Difficult to sinter materials, such as spinel, are typically mixed with a sintering aid or a secondary material that aids in densification. The sintering aids work in a variety of fashions. The sintering aids may liquefy at or somewhat below the primary material's densification temperature thereby promoting liquid phase sintering. Certain sintering aid materials exhibit higher solid-state diffusion coefficients than the primary material's self-diffusion coefficient. The secondary material may conversely have a lower solid-state diffusion coefficient that prevents exaggerated grain growth and promotes grain boundary refinement and pinning. The sintering aid may also simply clean or etch the primary material's surfaces thereby enhancing solid-state diffusion. These are broad examples of the mechanisms by which sintering aids enhance densification. In actual practice, sintering aids may not fit into just one of the categories outlined and the same aid may have different functions in different material systems, or have no effect in other systems.

Sintering aids tend to be solid inorganic particles at room temperature. Sintering aid particles henceforth are defined as comprising crystallites (≦500 nm), crystals (>500 nm), and agglomerates of crystallites and/or crystals. Since the materials to be densified are generally also solid inorganic particles, the two materials must be mixed homogeneously for the sintering aid to be effective. This is accomplished by some form of mechanical mixing. However, due to the nature of particle-particle interactions, the mixture is far from homogeneous. Inhomogeneity in the mixture results in areas that have too much sintering aid and other areas that have little or no sintering aid. This is a major problem in the fabrication of transparent ceramics, electronic ceramics, and in high tech refractory ceramics.

Magnesium aluminate (MgAl₂O₄) spinel is an attractive material for transparent armor and visible-infrared window applications due to its high melting point (2135° C.), high mechanical strength (150-300 MPa), and good abrasion resistance in addition to its excellent optical properties. Since spinel has a cubic crystal structure, its polycrystalline sample is transparent from UV to mid-IR range. Its superior optical transparency, especially in mid-IR region, and milder processing conditions are a big plus for spinel over its competitors: Aluminum oxinitride (AlON) and single crystal sapphire. Since spinel has an optically isotropic cubic structure, intrinsic scattering is not an issue, as we often see from non-cubic structured materials such as alumina. However spinel generally shows inferior flexural strength and hardness compared to sapphire and AlON, mainly due to its large grain size. The strength of the ceramics is inversely proportional to the size of its grains. Therefore it is critical to reduce the grain size to obtain high strength ceramic. In order to do this, it is also necessary to obtain nano-sized, high purity powders with narrow size distribution and low agglomeration to provide high optical transparency in ceramic spinel.

Various methods, including co-precipitation, alkoxide (sol-gel), spray pyrolysis, and mechanical activation, have been reported to produce high purity, fine spinel powders. Among them the precipitation of the hydroxide using inorganic salt in a base condition is the most convenient and cost effective technique. Also, it is suitable for mass production of powders. Although this method provides a convenient synthesis route to make homogeneous powder production, the final product always consists of micron-size hard agglomerates. They require an additional ball-milling or jet-milling process to break down the hard particles into fine powder. The powder still contains smaller sized hard agglomerates even after milling. This step is sometimes problematic especially for the production of transparent ceramic where the transparency is affected by even with ppm level of impurities since the powder can be contaminated during the process.

Synthesis of the spinel hydroxide precursor by co-precipitation consists of steps preparing an aqueous solution containing desired cations and mixing with another solution which contains the precipitating agent. Typically, a mixed solution of Al(III) and Mg(II) nitrate (sulphate, chloride, oxalate or their mixtures) with desired mole ratio is slowly added to the precipitation solution under vigorous stirring. Examples of the precipitation agents include ammonium hydroxide, various carbonate derivatives, urea, KOH, NaOH and/or their mixtures. Several parameters, such as pH, addition rate, temperature, and concentration, must be controlled to produce satisfactory results. After the precipitation is completed, the gel-like dispersion is filtered and washed with DI water to remove the byproducts and excessive unreacted materials. The precipitates, in general, are gel-like form and they are very hard to filter. Upon drying, they form hard agglomerates with sizes of up to several 10's of microns and it is extremely difficult to break into smaller particles with softer agglomerates. Hard agglomeration is believed to be caused by the strong intra- and/or inter-molecular hydrogen bonding between precursor hydroxides and water molecules. Small and extremely polar water molecules attract the hydroxide precursors to pack close together upon drying. It causes the hydroxide molecules to agglomerate together during the drying process. Once they are in the form of agglomerates, it is almost impossible to break them into loose particles. Even after a series of milling processes, it produces powders with the particle size as large as 10 microns. The powders become even harder after calcination and it makes the subsequent process very complicated and troublesome. Therefore it is important to prevent the hard agglomeration before they start to form.

### BRIEF SUMMARY OF THE INVENTION

Disclosed is a method of producing a spinel powder comprising preparing a double-hydroxide precursor precipitate then treating the precipitate with a washing agent, wherein said washing agent replaces water in said precipitate, then drying the precipitate to produce a hydroxide powder. The hydroxide powder is calcinated to produce an spinel powder that is essentially free of agglomeration. The calcinating is conducted at a temperature ranging from about 400° C. to about 1300° C. The resulting spinel powder has a particle size ranging from about 20 nm to about 100 nm and a BET surface area ranging from about 50 m2/g to about 200 m2/g. The present invention provides a solution to this problem.

### BRIEF DESCRIPTION OF THE DRAWINGS

FIG. 1 is a FIG. 1 is a Scanning Electron Microscopy of the spinel nano-powder synthesized by the present method.

### DETAILED DESCRIPTION OF THE INVENTION

Disclosed is a technique for preventing or minimizing the formation of hard agglomeration in making spinel powders. The method replaces a major portion, i.e., at least 50%, of the water molecules in the gel-like cake precipitate with a “washing agent”, defined herein as a bulky (but still miscible with water) agent that will prevent the formation of closely packed hard agglomerate. More preferably, the washing agent removes essentially all of the water from the gel-like cake. The washing agent can be selected from various organic and inorganic solvents with or without hydrogen bonding capability, acids and bases. The washing agent is typically a “polar aprotic solvent” and mixtures thereof. Examples of washing agents include, but are not limited to, acetone, ethyl acetate, tetrahydrofuran (THF), methyl ethyl ketone, acetonitrile, N,N-dimethylformamide (DMF), dimethyl sulfoxide (DMSO), dioxand, N-methylpyrrolidinone (NMP), hexamethylphosphorotriamide and mixtures thereof. This method produces agglomeration-free (or easily breakable soft agglomerates in some cases), ultrafine spinel nano-powders.

This invention disclosure describes a method of forming ultrafine spinel powders (nanometer size) without agglomerated particles which are ideal for making transparent ceramic materials with high mechanical strength for IR window and missile dome applications. This method includes steps of treatment of the double-hydroxide precursors (Aluminum hydroxide and Magnesium hydroxide) with liquid medium (or in combination with DI water) which is miscible with water. This technique provides convenient synthesis route to produce loosely bound hydroxide, which in turn, results in uniform nano-sized spinel powders upon calcination. The medium can be selected from any water-miscible medium/mediums. They include various organic and inorganic solvents, acids and bases. The hydroxide precursors, upon calcination, produce agglomerate-free, nano-sized fine spinel powder. This technique, in combination with spray drying in some cases, will dramatically simplify the process of manufacturing agglomeration-free spinel nanopowder.

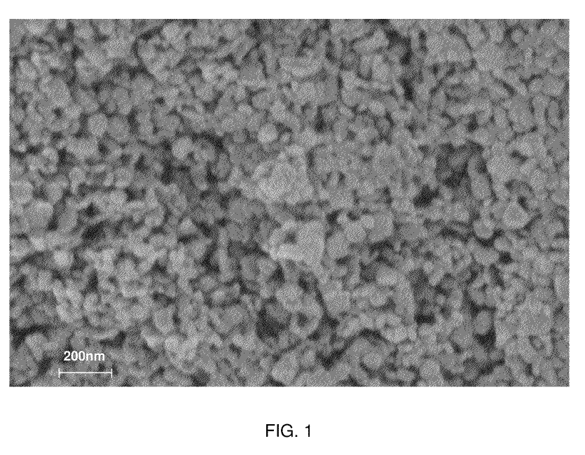

FIG. 1 shows a scanning electron microscopy of the spinel nano-powder synthesized by this invention. Agglomerate-free spinel nano-powders (ranging from about 20 to about 100 nm) are clearly shown.

### EXAMPLE 1

A mixed solution of magnesium chloride hexahydrate and aluminum chloride hexahydrate (Mg²⁺/Al³⁺=1:2) was prepared in DI water and heated in a beaker. The chloride solution was dropped into a warm ammonium hydroxide solution at a constant dropping rate using a peristaltic pump under vigorous stirring. The pH was carefully monitored and maintained at proper level, typically between 8.5 and 11. The reaction mixture was continued to be stirred for 1 hour and cooled to room temperature. The cooled mixture was filtered and washed with DI water. The wet precursor cake was transferred to a beaker containing washing agent and the mixture was stirred (and/or sonicated) until a major portion of water was replaced with washing agent. The mixture is divided into three parts: Part one was filtered and dried in an oven, Part two was transferred to a beaker and heated to slowly evaporate the agent on a hotplate until it dried. The loosely packed powder cake obtained from part 1 and 2 was ground with pestle and mortar and stored in a separate sample bottles. Part three was dried with a Spray drier. Agglomerate-free spinel nanopowders were obtained after calcination of the hydroxide powder at a temperature between 400° C. and 1300° C. In case where soft agglomerates are formed, a mild milling is employed to break them into nano-powders. Typically BET surface area of the final spinel powder is in the range of 50˜200 m²/g.

### EXAMPLE 2

A mixed solution of magnesium nitrate hexahydrate and aluminum nitrate nonahydrate (Mg²⁺/Al³⁺=1:2) was prepared in DI water and heated in a beaker. The nitrate solution was dropped to a warm ammonia water solution at a constant dropping rate using a peristaltic pump under vigorous stirring. The pH was carefully monitored and maintained at proper level, typically between 8.5 and 11. The reaction mixture was continued to be stirred for 1 hour and cooled to room temperature. The cooled mixture was filtered and washed with DI water. The wet precursor cake was transferred to a beaker containing washing agent and the mixture was stirred (or sonicated) until a major portion of water was replaced with washing agent. The mixture is divided into three parts: Part one was filtered and dried in an oven, part two was transferred to a beaker and heated to slowly evaporate the agent on a hotplate until it dried. The loosely packed powder cake obtained from parts 1 and 2 were ground with pestle and mortar and stored in a separate sample bottles. Part three was dried with a Spray drier. Agglomerate-free spinel nanopowders were obtained after calcination of the hydroxide powder at a temperature between 400° C. and 1300° C. In case where soft agglomerates are formed, a mild milling is employed to break them into nano-powders. Typically BET surface area of the final spinel powder is in the range of 50˜200 m²/g.

### EXAMPLE 3

A mixed solution of magnesium sulphate hydrate and aluminum sulphate heptahydrate (Mg²⁺/Al³⁺=1:2) was prepared in DI water and heated in a beaker. The sulphate solution was dropped to a warm ammonia water solution at a constant dropping rate using a peristaltic pump under vigorous stirring. pH was carefully monitored and maintained at proper level, typically between 8.5 and 11. The reaction mixture was continued to be stirred for 1 hour and cooled to room temperature. The cooled mixture was filtered and washed with DI water. The wet precursor cake was transferred to a beaker containing washing agent and the mixture was stirred (or sonicated) until a major portion of water was replaced with washing agent. The mixture is divided into three parts: Part one was filtered and dried in an oven. Part two was transferred to a beaker and heated to slowly evaporate the agent on a hotplate until it dried. The loosely packed powder cake obtained from part 1 and 2 was ground with pestle and mortar and stored in a separate sample bottles. Part three was dried with a Spray drier. Agglomerate-free spinel nanopowders were obtained after calcination of the hydroxide powder at a temperature between 400° C. and 1300° C. In case where soft agglomerates are formed, a mild milling is employed to break them into nano-powders. Typically BET surface area of the final spinel powder is in the range of 50˜200 m2/g.

The resulting spinel nanopowder was mechanically mixed with a sintering agent (in this case LiF, but could be any appropriate sintering aid) and then densified by hot pressing. spinel nano-powder made by the procedures described in Examples 1˜3 was hot pressed approximately 100° C. lower than using typical agglomerated commercial powder. A typical heating schedule was: ramp 20° C./min to 950° C. hold 30 min., ramp 20° C./min to 1200° C. and hold 30 min, and ramp 20° C./min to 1550° C. (1650° C. in case of agglomerated powder) hold 1 to 6 hours under vacuum and 8000 psi pressure. The samples were then hot isostatically pressed to complete transparency.

The previous synthesis method provides powders with hard agglomeration and inhomogeneous samples. The powder obtained by the presently disclosed treatment provides homogeneous nanopowders without hard agglomeration which are suitable for window and dome applications. This technique simplifies the whole process since some steps that are necessary for producing uniform nano-powder, such as milling, may not be required.

Obviously, many modifications and variations of the present invention are possible in light of the above teachings. It is therefore to be understood that, within the scope of the appended claims, the invention may be practiced otherwise than as specifically described.

What is claimed as new and desired to be protected by Letters Patent of the United States is:

1. A method of producing a spinel powder comprising
preparing a double-hydroxide precursor precipitate;
treating said precipitate with a washing agent, wherein said washing agent replaces water in said precipitate;
drying said precipitate to produce a hydroxide powder; and
calcinating said hydroxide powder to produce an spinel powder essentially free of agglomeration.

2. The method of claim 1 wherein said washing agent is comprised of at least one polar aprotic solvent.

3. The method of claim 1 wherein said washing agent is comprised of acetone, ethyl acetate, tetrahydrofuran, methyl ethyl ketone, acetonitrile, N,N-dimethylformamide, dimethyl sulfoxide, dioxand, N-methylpyrrolidinone, or hexamethylphosphorotriamide and mixtures thereof.

4. The method of claim 1 wherein said washing agent is miscible in water.

5. The method of claim 1 wherein said calcinating is conducted at a temperature ranging from about 400° C. to about 1300° C.

6. The method of claim 1 wherein said spinel powder has a particle size ranging from about 20 nm to about 100 nm.

7. The method of claim 1 wherein said spinel powder has a BET surface area ranging from about 50 m²/g to about 200 m²/g.

8. The method of claim 1 further comprising milling any soft aggregates into powders.

9. The method of claim 1 wherein said washing agent replaces at least 50% of the water in said precipitate.

10. The method of claim 1 wherein said washing agent replaces essentially all of the water in said precipitate.

11. A spinel nanopowder produced by the method of claim 1.

12. The spinel powder of claim 11, wherein said powder has a particle size ranging from about 20 nm to about 100 nm.

13. The spinel powder of claim 11, wherein said powder has a BET surface area ranging from about 50 m²/g to about 200 m²/g.

14. A spinel nanopowder having a particle size ranging from about 20 nm to about 100 nm.

15. The spinel nanopowder of claim 14 comprising a BET surface area ranging from about 50 m²/g to about 200 m²/g.

16. A method of making a transparent spinel material comprising
mixing the spinel nanopowder of claim 1 with sintering agent;
densifying said mixture; and
hot isotatically pressing said densified mixture to complete transparency.
